(19) United States
(12) Patent Application Publication
(10) Pub. No.: US 2024/0348758 A1
(43) Pub. Date: Oct. 17, 2024

(54) LASER PROJECTION APPARATUS AND DISPERSION CORRECTION METHOD FOR PROJECTION IMAGE

(71) Applicant: HISENSE LASER DISPLAY CO., LTD, Qingdao (CN)

(72) Inventors: Yingkai ZHANG, Qingdao (CN); Kaihua LIANG, Qingdao (CN); Dongdong ZHANG, Qingdao (CN)

(73) Assignee: HISENSE LASER DISPLAY CO., LTD, Qingdao (CN)

(21) Appl. No.: 18/645,915

(22) Filed: Apr. 25, 2024

Related U.S. Application Data
(63) Continuation of application No. PCT/CN2022/122692, filed on Sep. 29, 2022.

(30) Foreign Application Priority Data
Oct. 29, 2021 (CN) 202111268554.6
Nov. 11, 2021 (CN) 202111334947.2
May 26, 2022 (CN) 202210589268.8

(51) Int. Cl. H04N 9/31

(52) U.S. Cl. CPC H04N 9/3185; H04N 9/3161

(57) ABSTRACT

A laser projection apparatus and a dispersion correction method for a projection image are provided. The laser projection apparatus includes a laser source assembly, a light modulation assembly, a projection lens, and a controller. The controller is configured to: obtain a first projection image; determine a dispersion correction parameter according to a position of an image of a reference color on a screen and a position of an image of an adjusted color on the screen; and correct an image to be projected according to the dispersion correction parameter, and transmit an image signal of the corrected image to be projected to the light modulation assembly, so as to make the light modulation assembly modulate illumination beams to obtain projection beams by using the image signal. The reference color is one of a plurality of primary colors and different from the adjusted color.

### CROSS-REFERENCE TO RELATED APPLICATIONS

This application is a continuation application of International Patent Application No. PCT/CN2022/122692, filed on Sep. 29, 2022, which claims priority to Chinese Patent Application No. 202111268554.6, filed on Oct. 29, 2021; Chinese Patent Application No. 202111334947.2, filed on Nov. 11, 2021; and Chinese Patent Application No. 202210589268.8, filed on May 26, 2022, which are incorporated herein by reference in their entireties.

### TECHNICAL FIELD

The present disclosure relates to the field of projection display, and in particular, to a laser projection apparatus and a dispersion correction method for a projection image.

### BACKGROUND

Laser projection apparatuses may include laser source assemblies. Laser beams emitted by the laser source assembly are projected onto a screen to display a projection image.

### SUMMARY

In an aspect, a laser projection apparatus is provided. The laser projection apparatus includes a laser source assembly, a light modulation assembly, a projection lens, and a controller. The laser source assembly is configured to provide illumination beams. The light modulation assembly is configured to modulate the illumination beams to obtain projection beams by using an image signal of an image to be projected. The image to be projected includes a first image. The projection lens is configured to project the projection beams into an image. The controller is connected to the light modulation assembly and configured to: obtain a first projection image; determine a dispersion correction parameter according to a position of an image of a reference color on a screen and a position of an image of an adjusted color on the screen; and correct the image to be projected according to the dispersion correction parameter, and transmit the image signal of the corrected image to be projected to the light modulation assembly, so as to make the light modulation assembly modulate the illumination beams to obtain the projection beams by using the image signal of the corrected image to be projected. The first projection image is a projection image of the first image projected onto the screen. The first image includes images of a plurality of primary colors. The plurality of primary colors include the reference color and the adjusted color. The reference color is one of the plurality of primary colors and different from the adjusted color.

In another aspect, a dispersion correction method for a projection image is provided. The method is applied to a laser projection apparatus. The laser projection apparatus includes a laser source assembly, a light modulation assembly, a projection lens, and a controller. The method is executed by the controller. The method includes: obtaining a first projection image; determining a dispersion correction parameter according to a position of an image of a reference color on a screen and a position of an image of an adjusted color on the screen; and correcting an image to be projected according to the dispersion correction parameter, and transmitting an image signal of the corrected image to be projected to the light modulation assembly, so as to make the light modulation assembly modulate illumination beams to obtain projection beams by using the image signal of the corrected image to be projected. The first projection image is a projection image of a first image projected onto the screen. The first image includes images of a plurality of primary colors. The plurality of primary colors include the reference color and the adjusted color. The reference color is one of the plurality of primary colors and different from the adjusted color.

### BRIEF DESCRIPTION OF THE DRAWINGS

FIG. 1 is a diagram showing a structure of a laser projection apparatus, in accordance with some embodiments;

FIG. 2 is a diagram showing a beam path of a laser source assembly, a light modulation assembly, and a projection lens in a laser projection apparatus, in accordance with some embodiments;

FIG. 3 is a diagram showing a beam path of a laser source assembly in a laser projection apparatus, in accordance with some embodiments;

FIG. 4 is a diagram showing a principle of projection imaging by a laser projection apparatus, in accordance with some embodiments;

FIG. 5 is a diagram showing an arrangement of micromirrors in a digital micromirror device, in accordance with some embodiments;

FIG. 6 is a diagram showing a swing position of a micromirror in the digital micromirror device shown in FIG. 5;

FIG. 7 is a schematic diagram showing operation of micromirrors, in accordance with some embodiments;

FIG. 8 is a schematic diagram of a dispersion phenomenon, in accordance with some embodiments;

FIG. 9 is a block diagram of a laser projection apparatus, in accordance with some embodiments;

FIG. 10 is another schematic diagram of a dispersion phenomenon, in accordance with some embodiments;

FIG. 11 is a schematic diagram of a projection position of a corrected image to be projected, in accordance with some embodiments;

FIG. 12 is a diagram showing a structure of a first coordinate system, in accordance with some embodiments;

FIG. 13 is a block diagram of another laser projection apparatus, in accordance with some embodiments;

FIG. 14 is a diagram showing a structure of a second coordinate system, in accordance with some embodiments;

FIG. 15 is a diagram showing a structure of a red checkerboard image, in accordance with some embodiments;

FIG. 16 is a schematic diagram of third projection positions, in accordance with some embodiments;

FIG. 17 is a schematic diagram showing a position relationship among a third projection position, an orthogonal projection point of a projection lens, and an intersection between an optical axis of the projection lens and a screen, in accordance with some embodiments;

FIG. 18 is a schematic diagram showing a dispersion corresponding relationship, in accordance with some embodiments;

FIG. 19 is a flow chart of a dispersion correction method for a projection image, in accordance with some embodiments;

FIG. 20 is another flow chart of a dispersion correction method for a projection image, in accordance with some embodiments;

FIG. 21 is yet another flow chart of a dispersion correction method for a projection image, in accordance with some embodiments;

FIG. 22 is yet another flow chart of a dispersion correction method for a projection image, in accordance with some embodiments;

FIG. 23 is yet another flow chart of a dispersion correction method for a projection image, in accordance with some embodiments;

FIG. 24 is yet another flow chart of a dispersion correction method for a projection image, in accordance with some embodiments;

FIG. 25 is yet another flow chart of a dispersion correction method for a projection image, in accordance with some embodiments;

FIG. 26 is yet another flow chart of a dispersion correction method for a projection image, in accordance with some embodiments;

FIG. 27 is yet another flow chart of a dispersion correction method for a projection image, in accordance with some embodiments; and

FIG. 28 is yet another flow chart of a dispersion correction method for a projection image, in accordance with some embodiments.

### DETAILED DESCRIPTION

Some embodiments of the present disclosure will be clearly and completely described below with reference to the accompanying drawings. However, the described embodiments are merely some, but not all embodiments of the present disclosure. All other embodiments obtained by a person of ordinary skill in the art based on embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

As used herein, the term “if” is, optionally, construed as “when” or “in a case where” or “in response to determining that” or “in response to detecting,” depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event].”

The use of the phase “applicable to” or “configured to” herein means an open and inclusive expression, which does not exclude devices that are applicable to or configured to perform additional tasks or steps.

The terms such as “about,” “substantially,” and “approximately” as used herein include a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system). For example, the term “parallel” includes absolute parallelism and approximate parallelism, and an acceptable deviation range of the approximate parallelism may be, for example, a deviation within 5°. The term “perpendicular” includes absolute perpendicularity and approximate perpendicularity, and an acceptable deviation range of the approximate perpendicularity may also be, for example, a deviation within 5°. The term “equal” includes absolute equality and approximate equality, and an acceptable deviation range of the approximate equality may be that, for example, a difference between the two that are equal is less than or equal to 5% of either of the two.

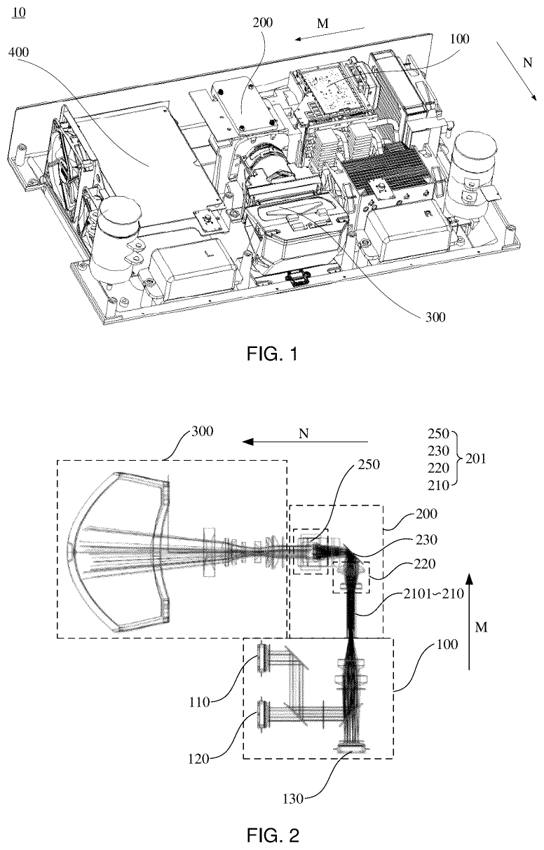

In some embodiments of the present disclosure, a laser projection apparatus is provided. As shown in FIG. 1, the laser projection apparatus includes a host 10. The host 10 includes a laser source assembly 100, a light modulation assembly 200, and a projection lens 300. The laser source assembly 100 is configured to provide illumination beams (e.g., laser beams or fluorescent beams). The light modulation assembly 200 is configured to modulate the illumination beams provided by the laser source assembly 100 to obtain projection beams by using an image signal. The projection lens 300 is configured to project the projection beams into an image on a screen or a wall.

The laser source assembly 100, the light modulation assembly 200, and the projection lens 300 are sequentially connected in a propagation direction of beams, and each is wrapped by a corresponding housing. The housings of the laser source assembly 100, the light modulation assembly 200, and the projection lens 300 support their corresponding optical components, respectively, and make the optical components meet certain sealing or airtight requirements.

As shown in FIG. 1, a first end of the light modulation assembly 200 is connected to the laser source assembly 100, and the laser source assembly 100 and the light modulation assembly 200 are arranged in an exit direction (referring to the direction M shown in FIG. 1) of the illumination beams of the laser projection apparatus. A second end of the light modulation assembly 200 is connected to the projection lens 300, and the light modulation assembly 200 and the projection lens 300 are arranged in an exit direction (referring to the direction N shown in FIG. 1) of the projection beams of the laser projection apparatus. The direction M is substantially perpendicular to the direction N. In one aspect, such connection structure may adapt to characteristics of a beam path of a reflective light valve in the light modulation assembly 200, and in another aspect, it is also conducive to shortening a length of a beam path in a one-dimensional direction, which is helpful for structural arrangement of the laser projection apparatus. For example, in a case where the laser source assembly 100, the light modulation assembly 200, and the projection lens 300 are disposed in a one-dimensional direction (e.g., the direction M), the length of the beam path in the one-dimensional direction is long, which is not conducive to the structural arrangement of the laser projection apparatus.

In some embodiments, the laser source assembly 100 includes a plurality of laser devices, and each laser device is a laser device corresponding to one of a plurality of primary colors. For example, as shown in FIG. 2, in an example where the laser source assembly 100 includes three laser devices, the three laser devices may include a red laser device 130, a green laser device 120, and a blue laser device 110, but the present disclosure is not limited thereto. The three laser devices may also all be blue laser devices 110, or two laser devices may be blue laser devices 110 and one laser device may be the red laser device 130.

In a case where the plurality of laser devices may provide laser beams of three primary colors (e.g., blue, green, and red), the laser source assembly 100 may provide the illumination beams including the laser beams of three primary colors. Therefore, there is no need to provide a phosphor wheel in the laser source assembly 100, which may simplify the structure of the laser source assembly 100 and reduce the volume of the laser source assembly 100. In a case where one or more laser devices included by the laser source assembly 100 may provide laser beams of one or two colors, it is necessary to use the laser beams of the existing color to excite the phosphor wheel to generate fluorescent beams of other colors, so that the laser beams and the fluorescent beams form white beams together.

In some embodiments, the laser source assembly 100 may further include two laser devices. In an example where the laser source assembly 100 is a dual-color laser source, the two laser devices may be the blue laser device 110 and the red laser device 130. In some other embodiments, the laser source assembly 100 may further include one laser device. That is to say, the laser source assembly 100 is a single-color laser source. In some examples, the laser source assembly 100 includes only the blue laser device 110, or only the red laser device 130, or only the green laser device 120.

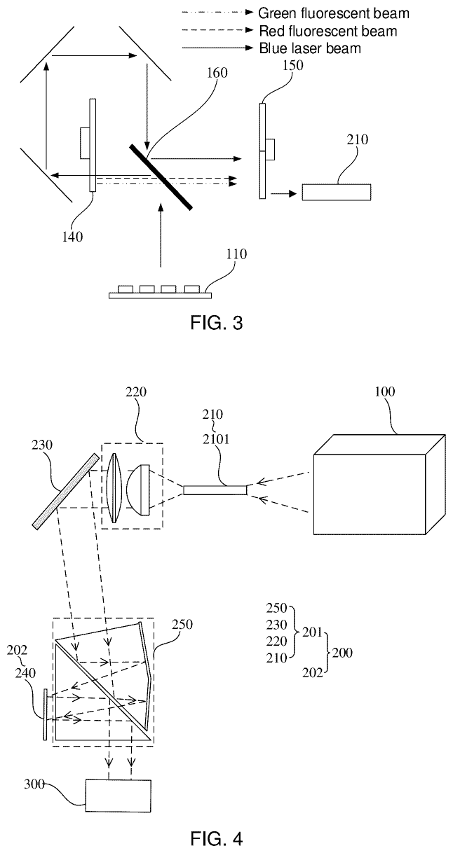

For example, as shown in FIG. 3, the laser source assembly 100 includes one blue laser device 110, and the laser source assembly 100 further includes a phosphor wheel 140 and a filter wheel 150. After the blue laser device 110 emits blue laser beams, a portion of the blue laser beams irradiates on the phosphor wheel 140, so that red fluorescent beams and green fluorescent beams are generated. The blue laser beams, the red fluorescent beams, and the green fluorescent beams are filtered by the filter wheel 150 after sequentially being incident on the filter wheel 150 through a combining lens 160. The laser source assembly 100 outputs the laser beams of three primary colors sequentially. Due to a phenomenon of visual perception of human eyes, the human eyes cannot distinguish the color of the laser beam at a certain moment, and what the human eyes see is still mixed white beams. It will be noted that in a case where the laser source assembly 100 includes the red laser device 130, there is no need for the phosphor wheel 140 to generate the red fluorescent beams.

Some embodiments of the present disclosure are described by considering an example in which the illumination beams provided by the laser source assembly 100 include the laser beams of a plurality of primary colors.

The illumination beams emitted by the laser source assembly 100 enter the light modulation assembly 200. As shown in FIGS. 2 and 4, the light modulation assembly 200 includes an illumination lens group 201 and a light modulation device (or the light valve) 202. The illumination lens group 201 is configured to receive the illumination beams provided by the laser source assembly 100 and propagate the illumination beams to the light modulation device 202 at a set angle and direction. The light modulation device 202 is configured to modulate the illumination beams to obtain the projection beams and reflect the projection beams into the projection lens 300.

In some embodiments, as shown in FIGS. 2 and 4, the illumination lens group 201 includes a homogenizing component 210, a lens group 220, and a prism group 250. The homogenizing component 210 is configured to receive the illumination beams provided by the laser source assembly 100 and homogenize the illumination beams. The lens group 220 is configured to converge the illumination beams exiting from the homogenizing component 210 to the prism group 250. The prism group 250 is configured to reflect the illumination beams to the light modulation device 202.

In some embodiments, as shown in FIGS. 2 and 4, the homogenizing component 210 includes a light pipe 2101. A light outlet of the light pipe 2101 may be in a shape of a rectangle, so as to have a shaping effect on a beam spot. In this way, the shape of the beam spot of the illumination beams exiting from the light pipe 2101 may match a rectangular laser-receiving surface of the light modulation device 202. Alternatively, the homogenizing component 210 may include a fly-eye lens. The fly-eye lens may homogenize the incident illumination beams and shape the illumination beams, so as to output a rectangular beam spot.

In some embodiments, as shown in FIGS. 2 and 4, the illumination lens group 201 further includes a reflector 230. The reflector 230 is located on a laser-exit side of the lens group 220 and configured to reflect the illumination beams exiting from the lens group 220 to the prism group 250.

In some embodiments, as shown in FIG. 4, the light modulation device 202 includes a digital micromirror device (DMD) 240.

The DMD 240 is a core component in the light modulation assembly 200 and configured to modulate the illumination beams provided by the laser source assembly 100 with image signals. That is to say, the digital micromirror device 240 controls the illumination beams to display different luminance and gray scales according to different pixels in an image to be projected, so as to finally produce an optical image.

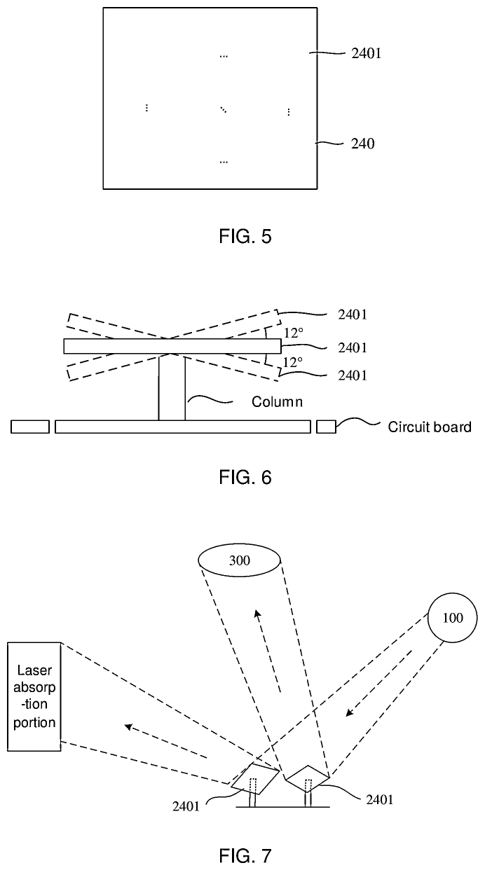

The DMD 240 is applied in the Digital Light Processing (DLP) projection architecture, as shown in FIGS. 2 and 4, and the light modulation assembly 200 uses the DLP projection architecture. As shown in FIG. 5, the DMD 240 includes thousands of micromirrors 2401 that may be individually driven to rotate. These micromirrors 2401 are arranged in an array. One micromirror 2401 (e.g., each micromirror 2401) corresponds to one pixel in the image to be projected. In the DLP projection architecture, each micromirror 2401 is equivalent to a digital switch. The micromirror 2401 may swing within a range of plus or minus 12° (i.e., ±12°) or a range of plus or minus 17° (i.e., ±17°) due to an action of an external electric field, so that the reflected beam may be imaged on the screen along an optical axis direction by the projection lens 300, forming a bright pixel.

For example, as shown in FIG. 6, for the micromirrors 2401 with the deflection angles of ±12°, a state at +12° is an ON state, and a state at −12° is an OFF state. For a deflection angle between −12° and +12°, actual operating states of the micromirror 2401 are only the ON state and the OFF state. As shown in FIG. 7, a laser beam reflected by the micromirror 2401 at a negative deflection angle is referred to as an OFF laser beam, and the OFF laser beam is an ineffective laser beam, and which usually irradiates on the housing of the light modulation assembly 200, or is absorbed by a laser absorption portion. A laser beam reflected by the micromirror 2401 at a positive deflection angle is referred to as an ON laser beam. The ON laser beam is an effective beam reflected by the micromirror 2401 on a surface of the DMD 240 when the micromirror 2401 receives irradiation of the illumination beams, and the ON laser beam enters the projection lens 300 at a positive deflection angle for projection imaging. In a display cycle of a frame of an image, some or all of the micromirrors 2401 are switched once between the ON state and the OFF state, so that gray scales of pixels in the frame of the image are achieved according to durations of the micromirrors 2401 in the ON state and the OFF state.

The homogenizing component 210, the lens group 220, and the reflector 230 at a front end of the DMD 240 form an illumination path, and the illumination beams emitted by the laser source assembly 100 have a size and an incident angle which satisfy the requirements of the DMD 240 after passing through the illumination path.

As shown in FIG. 2, the projection lens 300 includes a combination of a plurality of lenses, which are usually divided by groups, and are divided into a three-segment combination including a front group, a middle group, and a rear group, or a two-segment combination including a front group and a rear group. The front group is a lens group proximate to a laser-exit side (i.e., a side of the projection lens 300 away from the light modulation assembly 200 in the direction N in FIG. 2) of the laser projection apparatus, and the rear group is a lens group proximate to a laser-exit side (i.e., a side of the projection lens 300 proximate to the light modulation assembly 200 in the opposite direction of the direction N in FIG. 2) of the light modulation assembly 200. The projection lens 300 may include a zoom projection lens, or a prime focus-adjustable projection lens, or a prime projection lens according to the combination of the plurality of lenses.

In some embodiments, the laser projection apparatus is an ultra-short-focus projection apparatus, and the projection lens 300 is an ultra-short-focus projection lens. A projection ratio of the projection lens 300 is usually less than 0.3, such as 0.24. The projection ratio is a ratio of a projection distance to a width (or a diagonal length) of the projection image. In a case of a same projection distance, the less the projection ratio, the greater the width of the projection image. The ultra-short-focus projection lens with a lesser projection ratio may adapt to a narrow space while ensuring the projection effect. Here, the projection distance is the minimum distance between the projection lens 300 and the screen.

In summary, in the process of the laser projection apparatus projecting the image to be projected onto the screen, the laser source assembly 100 may provide the illumination beams including a plurality of primary colors, and the light modulation assembly 200 modulates the laser beams of the plurality of primary colors according to the image signal of the image to be projected. The modulated laser beams of the plurality of primary colors are incident into the projection lens 300 and projected into an image on the screen by the projection lens 300, so that the image to be projected is displayed on the screen.

However, the laser beams of the plurality of primary colors include laser beams of at least two different primary colors, and the laser beams of at least two different primary colors have different wavelengths. Therefore, the laser beams of at least two different primary colors have different refractive indexes in the lens, so that the laser beams of at least two different primary colors incident on a same position of any lens of the projection lens 300 have different imaging positions, and there is a deviation between the imaging positions. Such phenomenon is referred to as a dispersion phenomenon.

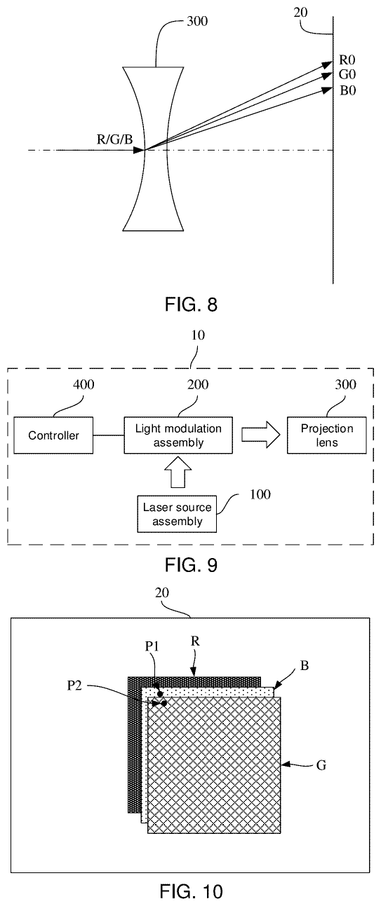

For example, as shown in FIG. 8, a projection position RO of a red beam, a projection position GO of a green beam, and a projection position BO of a blue beam are different from each other on a screen 20 after the illumination beams (R/G/B) including the red beam, the green beam, and the blue beam pass through any lens in the projection lens 300. In a case where the dispersion phenomenon is serious, the display effect of the projection image is affected. In the related art, the dispersion phenomenon is usually reduced by optimizing the projection lens of the laser projection apparatus. For example, the projection lens is optimized by changing curvature of the lens, or coating the lens with a film, or changing the material of the lens, but this manner may significantly increase the cost.

To this end, in some embodiments of the present disclosure, a laser projection apparatus is provided. The laser projection apparatus may determine a dispersion correction parameter and perform dispersion correction on an image to be projected according to the dispersion correction parameter, so that the light modulation assembly 200 modulates the illumination beams with the image signal of the corrected image to be projected, thereby reducing the dispersion phenomenon. Moreover, the projection effect of the laser projection apparatus is improved without increasing the cost.

In some embodiments, as shown in FIG. 9, the host 10 further includes a controller 400. The controller 400 is connected to the light modulation assembly 200 and configured to: obtain a first projection image; determine a dispersion correction parameter according to a position of an image of a reference color on the screen 20 and a position of an image of an adjusted color on the screen 20; and correct an image to be projected according to the dispersion correction parameter, and transmit an image signal of the corrected image to be projected to the light modulation assembly 200. As a result, the light modulation assembly 200 modulates the illumination beams to obtain the projection beams by using the image signal of the corrected image to be projected.

The image to be projected includes a first image. The first projection image is a projection image projected on the screen 20 by the first image. The first image includes images of a plurality of primary colors. The plurality of primary colors include a reference color and an adjusted color. The reference color is one of the plurality of primary colors and different from the adjusted color.

The method of correcting the image to be projected according to the dispersion correction parameter may be that: the image of the adjusted color in the image to be projected is shifted according to the dispersion correction parameter. The image of the reference color and the shifted image of the adjusted color constitute the corrected image to be projected. The controller 400 may send the image signal of the corrected image to be projected to the light modulation assembly 200, so that the DMD 240 may control the deflection angles and the durations corresponding to the deflection angles of the plurality of micromirrors 2401 according to the image signal of the corrected image to be projected. As a result, beams of the adjusted color and beams of the reference color may be incident on different positions of any lens of the projection lens 300, so that the deviation between the imaging position of the beams of the adjusted color and the imaging position of the beams of the reference color is reduced or disappears after the beams of the adjusted color and the beams of the reference color are incident on any lens of the projection lens 300.

In this way, the position of the image of the adjusted color on the screen 20 may be adjusted to be proximate to or the same as the position of the image of the reference color on the screen 20, so that the dispersion phenomenon may be reduced and the projection effect of the laser projection apparatus may be improved.

The image to be projected includes the first image. For example, the first image may be a startup image, a checkerboard image for dispersion correction, or any of frame images of the image to be projected. The first image is an image including a plurality of primary colors. The following is described by considering an example in which the first image includes images of three primary colors (red, green, and blue), and the illumination beams provided by the laser source assembly 100 includes a red beam, a green beam, and a blue beam.

In the process of the laser projection apparatus projecting the first image onto the screen 20 to form the first projection image, the laser source assembly 100 emits the red beam, the green beam, and the blue beam corresponding to the first image according to timing. Considering the red beam as an example, if receiving the red beam, the light modulation assembly 200 modulates the red beam and reflects the modulated red beam to the projection lens 300. A red image is imaged by the projection lens 300, so that a projection image of the red image is displayed on the screen 20. It may be understood that the projection lens 300 may also image a green image and a blue image, and the first projection image includes the projection image of the red image on the screen 20, the projection image of the green image on the screen 20, and the projection image of the blue image on the screen 20.

As shown in FIG. 10, in the first projection image, a position of a blue image B on the screen 20, a position of a green image G on the screen 20, and a position of a red image R on the screen 20 are different from each other. That is to say, there is a dispersion phenomenon. The controller 400 may adjust the position of at least one of the blue image B, the green image G, or the red image R on the screen 20, so as to reduce the dispersion phenomenon.

For example, the controller 400 may use a position of an image (e.g., the blue image B) of one of the plurality of primary colors on the screen 20 as a reference position, and make images (e.g., the red image R or the green image G) of other primary colors in addition to the one primary color on the screen 20 have positions proximate to or the same as the position of the image (the blue image B) of the one primary color on the screen 20. The one primary color may be referred to as the reference color, and any of the other primary colors may be referred to as the adjusted color. It may be understood that the position of the image of one of the plurality of primary colors on the screen 20 refers to the position of the projection image of the image of the one primary color on the screen 20.

For example, the reference color may be any of a plurality of primary colors, and the adjusted color may include the other primary colors other than the reference color in the plurality of primary colors. For example, if the plurality of primary colors include green, blue, and red, the reference color may be green, and the adjusted color may include red or blue. The present disclosure does not limit the color of the reference color or the adjusted color. The following is described by considering an example in which the reference color is blue and the adjusted color is red or green.

In some embodiments, the controller 400 may include a processor. The processor may include a central processing unit (CPU), a microprocessor, or an application specific integrated circuit (ASIC) and may be configured to execute the corresponding operations described in the controller 400 when the processor executes a program stored in a non-transitory computer-readable storage media coupled to the controller 400. The non-transitory computer-readable storage media may include a magnetic storage device (e.g., a hard disk, a floppy disk, or a magnetic tape), a smart card, or a flash memory device (e.g., an erasable programmable read-only memory (EPROM), a card, a stick, or a keyboard driver).

In some embodiments, the controller 400 may determine the dispersion correction parameter according to the position of the image of the adjusted color on the screen 20 and the position of the image of the reference color on the screen 20. For example, the dispersion correction parameter includes an offset of the position of the image of the adjusted color on the screen 20 with respect to the position of the image of the reference color on the screen 20.

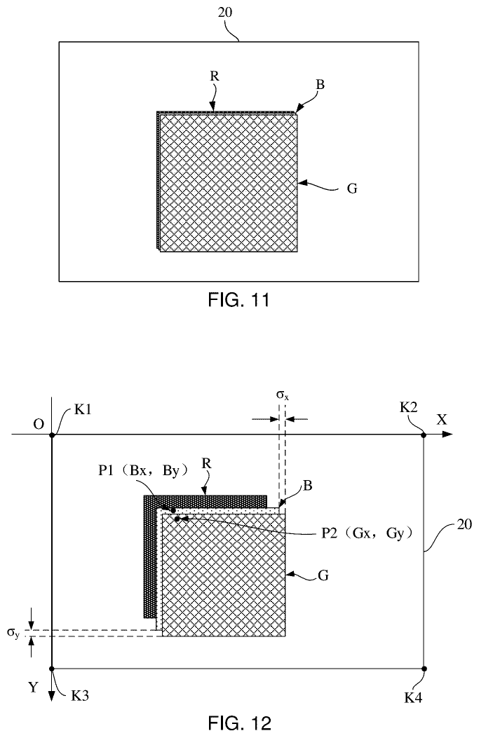

In this way, the controller 400 may correct the image of the adjusted color in the image to be projected according to the dispersion correction parameter and obtain the image signal of the corrected image to be projected. As a result, the light modulation assembly 200 modulates the illumination beams to obtain the projection beams by using the image signal of the corrected image to be projected, and the projection beams are projected from the projection lens 300 onto the screen 20, so as to form the image on the screen 20 as shown in FIG. 11. On the screen 20 shown in FIG. 11, there is a significant overlap among the position of the blue image B on the screen 20, the position of the green image G on the screen 20, and the position of the red image R on the screen 20.

In some embodiments, the controller 400 may be configured to: obtain a first projection position of a first pixel point in the image of the reference color on the screen 20; obtain a second projection position of a second pixel point in the image of the adjusted color on the screen 20; obtain an offset of the second projection position with respect to the first projection position; and obtain the dispersion correction parameter according to the offset. In this way, the dispersion correction parameter may be determined according to the position of the image of the adjusted color on the screen 20 and the position of the image of the reference color on the screen 20.

The first pixel point is any pixel point in the image of the reference color. The position of the second pixel point in the image of the adjusted color is the same as the position of the first pixel in the image of the reference color. That is to say, the first pixel point and the second pixel point are in a same position in the first image.

For example, the first image may include a plurality of pixel points, and any one of the plurality of pixel points may include image data of three primary colors. For example, a pixel point P is any pixel point in the first image. In the image of the reference color, the pixel point P may be referred to as the first pixel point, and in the image of the adjusted color, the pixel point P may be referred to as the second pixel point. That is to say, the position of the second pixel point in the image of the adjusted color is the same as the position of the first pixel point in the image of the reference color, which is the position of the pixel point P in the first image.

After the first image is projected onto the screen 20 by the laser projection apparatus, the first projection position of the first pixel point on the screen 20 is different from the second projection position of the second pixel point on the screen 20 due to the dispersion phenomenon. In this case, as shown in FIG. 10, the controller 400 may obtain a position deviation between the first projection position P1 and the second projection position P2 according to the first projection position P1 of the first pixel point in the image (the blue image B) of the reference color on the screen 20 and the second projection position P2 of the second pixel point in the image (the green image G) of the adjusted color on the screen 20. Here, the position deviation is an offset of the second projection position P2 with respect to the first projection position P1.

In some embodiments, the controller 400 may be configured to: obtain a first coordinate of the first projection position P1 in a first coordinate system and a second coordinate of the second projection position P2 in the first coordinate system; and determine the offset of the second projection position P2 with respect to the first projection position P1 according to the first coordinate and the second coordinate. The first coordinate system is a coordinate system established on the screen 20.

For example, in the screen 20, as shown in FIG. 12, the first coordinate system OXY may consider an upper left vertex of the screen 20 as origin, a horizontal direction of the screen 20 as a horizontal axis, and a vertical direction of the screen 20 as a vertical axis. The controller 400 may determine the offset of the second projection position P2 with respect to the first projection position P1 according to the first coordinate (Bx, By) and the second coordinate (Gx, Gy) after obtaining the first coordinate (Bx, By) of the first projection position P1 in the first coordinate system OXY and the second coordinate (Gx, Gy) of the second projection position P2 in the first coordinate system OXY. It may be understood that the first coordinate system OXY may also be established with a center point of the screen 20 as origin.

In some embodiments, the offset may include a row offset and a column offset. The row offset is an offset of the second coordinate with respect to the first coordinate in the horizontal direction of the screen 20, and the column offset is an offset of the second coordinate with respect to the first coordinate in the vertical direction of the screen 20.

For example, as shown in FIG. 12, the row offset of the second coordinate (Gx, Gy) with respect to the first coordinate (Bx, By) in the X-axis is σx, and the row offset σx is a difference between a horizontal coordinate of the second coordinate and a horizontal coordinate of the first coordinate (i.e., σx=Gx−Bx). The row offset may include an offset direction.

If σx is positive, the row offset indicates that the second coordinate is shifted by |σx| (|σx| is an absolute value of σx) pixels with respect to the first coordinate in a positive direction of the X-axis. In this way, the adjustment manner according to the row offset may be that the position of the image of the adjusted color on the screen 20 is shifted by |σx| pixels in a negative direction of the X axis.

If σx is negative, the row offset indicates that the second coordinate is shifted by |σx| pixels with respect to the first coordinate in the negative direction of the X-axis. In this way, the adjustment manner according to the row offset may be that the position of the image of the adjusted color on the screen 20 is shifted by |σx| pixels in the positive direction of the X-axis.

The column offset of the second coordinate (Gx, Gy) with respect to the first coordinate (Bx, By) in the Y-axis is oy. Similar to the row offset σx, the column offset oy may further include an offset direction.

In some embodiments, at least one of the row offset or the column offset is greater than a resolution of the projection lens 300. For example, if the projection lens 300 has a resolution of 0.5 pixels, the projection lens 300 is able to distinguish an absolute value of the row offset or the column offset in a case where the absolute value of the row offset or the column offset is greater than 0.5 pixels. In this way, the position of the image of the adjusted color on the screen 20 may be proximate to or the same as that of the image of the reference color on the screen 20 after the dispersion correction parameter are generated according to the absolute value of the row offset or the column offset and the image to be projected is corrected and projected according to the dispersion correction parameter.

How to obtain the first coordinate and the second coordinate is described in detail below.

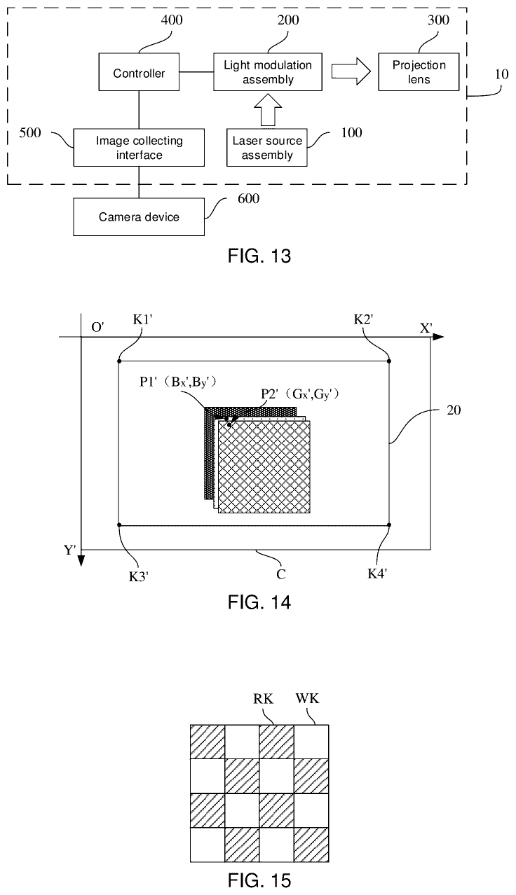

In some embodiments, as shown in FIG. 13, the host 10 further includes an image collecting interface 500. The image collecting interface 500 is connected to the controller 400. In this case, the controller 400 is further configured to: obtain a first captured image C through the image collecting interface 500; obtain a position of the first projection position P1 in the first captured image C and a position of the second projection position P2 in the first captured image C; and obtain the offset according to the position of the first projection position P1 in the first captured image C and the position of the second projection position P2 in the first captured image C. The first captured image C is an image captured by a camera device 600 when the first image is projected onto the screen 20.

For example, as shown in FIG. 14, the first captured image C obtained by the image collecting interface 500 includes the screen 20 and the first projection image on the screen 20. In order to obtain the position P1′ of the first projection position P1 in the first captured image C and the position P2′ of the second projection position P2 in the first captured image C, a second coordinate system O′X′Y′ may be established on the first captured image C.

In this case, the controller 400 is configured to: obtain a conversion parameter between the first coordinate system and the second coordinate system; obtain a third coordinate of the first projection position P1 in the second coordinate system and a fourth coordinate of the second projection position P2 in the second coordinate system; and obtain the offset according to the third coordinate, the fourth coordinate, and the conversion parameter. The first coordinate system is a coordinate system established on the screen 20. The second coordinate system is a coordinate system established on the first captured image C.

For example, a projection position (e.g., the first projection position P1 or the second projection position P2) is a projection position of a vertex of a color block in a checkerboard image of a primary color on the screen 20. A binary image of the first captured image C may be obtained by binarizing the first captured image C including the projection position. Then, a coordinate (e.g., the third coordinate or the fourth coordinate) of the projection position of the vertex of the color block in the second coordinate system is obtained by performing an edge detection on the binary image. The checkerboard image and the color block are described later.

In some embodiments, the controller 400 may also be configured to: obtain a fifth coordinate of a reference point in the first coordinate system and a sixth coordinate of the reference point in the second coordinate system; and obtain the conversion parameter between the first coordinate system and the second coordinate system according to the fifth coordinate and the sixth coordinate. The reference point is a point in the screen 20.

As shown in FIG. 14, the second coordinate system O′X′Y′ considers an upper left vertex of the first captured image C as origin, a horizontal direction of the first captured image C as a horizontal axis, and a vertical direction of the first captured image C as a vertical axis. It may be understood that the second coordinate system O′X′Y′ may also be established with a center point of the first captured image C as origin. The first coordinate system exists in a physical environment of the screen 20, the first captured image C is obtained by the camera device 600 capturing the physical environment of the screen 20, and the second coordinate system exists in the first captured image C. Therefore, the conversion parameter between the first coordinate system and the second coordinate system may also be referred to as a perspective transformation of the camera device 600.

For example, the camera device 600 is required to face the screen 20 to take a picture, so that the first captured image C includes the image of the whole screen 20. The camera device 600 may be disposed on the laser projection apparatus and communicate with the controller 400 through the image collecting interface 500. Alternatively, the camera device 600 may be a mobile camera device (e.g., a camera of a mobile phone), which may transmit the first captured image C to the controller 400 by means of a wireless connection (e.g., a Bluetooth connection).

When the reference point is selected, the reference point is required to exist in the physical environment of the screen 20 and the first captured image C. For example, the reference point may include a point in the screen 20, which is conducive to obtaining the fifth coordinate of the reference point in the first coordinate system and the sixth coordinate of the reference point in the second coordinate system. The conversion parameter between the first coordinate system and the second coordinate system may include a plurality of parameters, so that a plurality of reference points may be selected.

In an example where the reference point includes a plurality of points on the screen 20, the reference point may include four points on the screen 20, or the reference point may further include six points on the screen 20. The position and number of the reference points are not limited in the present disclosure, as long as the conversion parameter between the first coordinate system and the second coordinate system may be obtained according to the number of the reference points. The following is described by considering an example in which the conversion parameter between the first coordinate system and the second coordinate system includes eight parameters, and the reference point includes four vertices of the screen 20.

For example, as shown in FIG. 12, positions of the four vertices of the screen 20 in the physical environment of the screen 20 are positions K1, K2, K3, and K4, respectively, and the fifth coordinate includes coordinates of the positions K1, K2, K3, and K4 in the first coordinate system. It may be understood that the coordinates of the positions K1, K2, K3, and K4 in the first coordinate system are related to a size or a resolution of the screen 20. Therefore, the coordinates of the positions K1, K2, K3, and K4 in the first coordinate system OXY may be obtained in a case where the size or the resolution of the screen 20 is known.

For example, if the resolution of the screen 20 is SH×SW (i.e., the number of horizontal distinguishable pixel points of the screen 20 is SW, and the number of vertical distinguishable pixel points of the screen 20 is SH), the fifth coordinate includes (0, 0), (SW, 0), (0, SH), (SW, SH).

As shown in FIG. 14, the positions of the four vertices of the screen 20 in the first captured image C are positions K1, K2′, K3′, and K4′, respectively, and the sixth coordinate includes coordinates of the positions K1′, K2′, K3′, and K4′ in the second coordinate system O′X′Y′. In this case, the controller 400 may be configured to perform an edge detection on the first captured image C and identify the vertices of the screen 20, so as to obtain the positions of the four vertices of the screen 20 in the first captured image C, thereby obtaining the coordinates of the positions K1′, K2′, K3′, and K4′ in the second coordinate system O′X′Y′. Here, the edge detection is used to identify points with obvious brightness changes in the digital image.

In a case where the fifth coordinate and the sixth coordinate are obtained, the controller 400 is configured to determine the conversion parameter (i.e., the conversion parameter between the first coordinate system OXY and the second coordinate system O′X′Y′) according to the fifth coordinate and the sixth coordinate. How to obtain the conversion parameter between the first coordinate system OXY and the second coordinate system O′X′Y′ is described below.

As shown in the formula (1), a conversion relationship between the first coordinate system OXY and the second coordinate system O′X′Y′ may be expressed as a matrix.

$$w [ \begin{matrix}a \\ b \\ 1\end{matrix} ] = [ \begin{matrix}{k}_{0} & {k}_{1} & {k}_{2} \\ {k}_{3} & {k}_{4} & {k}_{5} \\ {k}_{6} & {k}_{7} & 1\end{matrix} ] [ \begin{matrix}x \\ y \\ 1\end{matrix} ] \qquad ( 1 )$$

In a formula (1), (x, y) represents a coordinate of any point of the screen 20 in the second coordinate system O′X′Y′, (a, b) represents a coordinate of any point of the screen 20 in the first coordinate system OXY, the letters k₀ to k₇ comprise the conversion parameter, and the letter w is a weight value.

A formula (2) is obtained by a matrix operation on the formula (1).

$$\begin{matrix}a = \frac{{k}_{0} \times x + {k}_{1} \times y + {k}_{2}}{w} \\ b = \frac{{k}_{3} \times x + {k}_{4} \times y + {k}_{5}}{w} \\ w = {k}_{6} \times x + {k}_{7} \times y + 1\end{matrix} \qquad ( 2 )$$

A formula (3) is obtained from formula (2).

$$\begin{matrix}a = {k}_{0} \times x + {k}_{1} \times y + {k}_{2} - {k}_{6} \times x \times a - {k}_{7} \times y \times a \\ b = {k}_{3} \times x + {k}_{4} \times y + {k}_{5} - {k}_{6} \times x \times b - {k}_{7} \times y \times b\end{matrix} \qquad ( 3 )$$

If the coordinates of the positions K1′, K2′, K3′, and K4′ in the second coordinate system O′X′Y′ are (x1, y1), (x2, y2), (x3, y3), and (x4, y4), respectively, and the coordinates of the positions K1, K2, K3, and K4 in the first coordinate system OXY are (a1, b1), (a2, b2), (a3, b3), and (a4, b4), respectively, a formula (4) is obtained by substituting the coordinates (x1, y1), (x2, y2), (x3, y3) and (x4, y4) and the coordinates (a1, b1), (a2, b2), (a3, b3) and (a4, b4) into the formula (3).

$$\begin{matrix}a 1 = {k}_{0} \times x 1 + {k}_{1} \times y 1 + {k}_{2} - {k}_{6} \times x 1 \times a 1 - {k}_{7} \times y 1 \times a 1 \\ b 1 = {k}_{3} \times x 1 + {k}_{4} \times y 1 + {k}_{5} - {k}_{6} \times x 1 \times b 1 - {k}_{7} \times y 1 \times b 1 \\ a 2 = {k}_{0} \times x 2 + {k}_{1} \times y 2 + {k}_{2} - {k}_{6} \times x 2 \times a 2 - {k}_{7} \times y 2 \times a 2 \\ b 2 = {k}_{3} \times x 2 + {k}_{4} \times y 2 + {k}_{5} - {k}_{6} \times x 2 \times b 2 - {k}_{7} \times y 2 \times b 2 \\ a 3 = {k}_{0} \times x 3 + {k}_{1} \times y 3 + {k}_{2} - {k}_{6} \times x 3 \times a 3 - {k}_{7} \times y 3 \times a 3 \\ b 3 = {k}_{3} \times x 3 + {k}_{4} \times y 3 + {k}_{5} - {k}_{6} \times x 3 \times b 3 - {k}_{7} \times y 3 \times b 3 \\ a 4 = {k}_{0} \times x 4 + {k}_{1} \times y 4 + {k}_{2} - {k}_{6} \times x 4 \times a 4 - {k}_{7} \times y 4 \times a 4 \\ b 4 = {k}_{3} \times x 4 + {k}_{4} \times y 4 + {k}_{5} - {k}_{6} \times x 4 \times b 4 - {k}_{7} \times y 4 \times b 4\end{matrix} \qquad ( 4 )$$

A formula (5) is obtained by expressing the formula (4) as a matrix.

$$[ \begin{matrix}a 1 \\ b 1 \\ a 2 \\ b 2 \\ a 3 \\ b 3 \\ a 4 \\ b 4\end{matrix} ] = [ \begin{matrix}x 1 & y 1 & 1 & 0 & 0 & 0 & - x 1 \times a 1 & - y 1 \times a 1 \\ 0 & 0 & 0 & x 1 & y 1 & 1 & - x 1 \times b 1 & - y 1 \times b 1 \\ x 2 & y 2 & 1 & 0 & 0 & 0 & - x 2 \times a 2 & - y 2 \times a 2 \\ 0 & 0 & 0 & x 2 & y 2 & 1 & - x 2 \times b 2 & - y 2 \times b 2 \\ x 3 & y 3 & 1 & 0 & 0 & 0 & - x 3 \times a 3 & - y 3 \times a 3 \\ 0 & 0 & 0 & x 3 & y 3 & 1 & - x 3 \times b 3 & - y 3 \times b 3 \\ x 4 & y 4 & 1 & 0 & 0 & 0 & - x 4 \times a 4 & - y 4 \times a 4 \\ 0 & 0 & 0 & x 4 & y 4 & 1 & - x 4 \times b 4 & - y 4 \times b 4\end{matrix} ] [ \begin{matrix}{k}_{0} \\ {k}_{1} \\ {k}_{2} \\ {k}_{3} \\ {k}_{4} \\ {k}_{5} \\ {k}_{6} \\ {k}_{7}\end{matrix} ] \qquad ( 5 )$$

Values of the conversion parameters k₀ to k₇ may be obtained by substituting the obtained coordinates (x1, y1), (x2, y2), (x3, y3), and (x4, y4) of the positions K1′, K2′, K3′, and K4′ in the second coordinate system O′X′Y′, and the obtained coordinates (a1, b1), (a2, b2), (a3, b3), and (a4, b4) of the positions K1, K2, K3, and K4 in the first coordinate system OXY into the formula (4) or the formula (5) for calculation.

In a case where the values of the conversion parameters k₀ to k₇ are obtained, the controller 400 is further configured to: obtain the first coordinate according to the third coordinate and the conversion parameter; and obtain the second coordinate according to the fourth coordinate and the conversion parameter.

For example, a formula (6) is obtained by substituting the third coordinate (Bx′, By′) of the position P1′ of the first projection position P1 in the first captured image C in the second coordinate system into the formula (2), so that the first coordinate (Bx, By) of the first projection position P1 in the first coordinate system is obtained according to the formula (6).

$$\begin{matrix}Bx = \frac{{k}_{0} \times B {x}^{′} + {k}_{1} \times B {y}^{′} + {k}_{2}}{w} \\ By = \frac{{k}_{3} \times B {x}^{t} + {k}_{4} \times B {y}^{′} + {k}_{5}}{w} \\ w = {k}_{6} \times B {x}^{′} + {k}_{7} \times {By}^{′} + 1\end{matrix} \qquad ( 6 )$$

Similarly, the second coordinate (Gx, Gy) of the second projection position P2 in the first coordinate system may be obtained by substituting the fourth coordinate (Gx′, Gy′) of the position P2′ of the second projection position P2 in the first captured image C in the second coordinate system into the formula (2).

In this way, the controller 400 may obtain the offset of the second projection position P2 with respect to the first projection position P1 according to the first coordinate (Bx, By) and the second coordinate (Gx, Gy). The process of obtaining the offset of the second projection position P2 with respect to the first projection position P1 according to the first coordinate and the second coordinate has been described above, and details will not be repeated herein.

In some embodiments, the controller 400 may obtain offsets of all second projection positions P2 with respect to the first projection positions P1 on the screen 20, so as to determine the dispersion correction parameter. Alternatively, the controller 400 may also obtain offsets of some second projection positions P2 with respect to the first projection position P1 on the screen 20, so as to reduce the computation for the controller 400.

In some examples, the first image may include checkerboard images of three primary colors. In the checkerboard images of three primary colors, a checkerboard image of each primary color includes a plurality of color blocks with a same size and a same shape. The plurality of color blocks may include a plurality of primary color blocks and a plurality of white color blocks. Any two primary color blocks are disposed at an interval (i.e., being not adjacent), and any two white color blocks are disposed at an interval (i.e., being not adjacent).

For example, as shown in FIG. 15, the red checkerboard image includes a plurality of color blocks with a same size and a shape of a square. The plurality of color blocks include a plurality of red color blocks RK and a plurality of white color blocks WK. Any two red color blocks RK are disposed at an interval, and any two white color blocks WK are disposed at an interval. In this case, a position of a vertex of each primary color block (e.g., the red color block RK) in the checkerboard image of the reference color on the screen 20 may be selected as the first projection position P1, so as to obtain the offset of the second projection position P2 with respect to the first projection position P1. In this way, the dispersion correction parameter may be determined while the computation for the controller 400 is reduced.

Therefore, the controller 400 may be configured to: obtain the resolution of the screen 20; and generate the checkerboard images of a plurality of primary colors according to the resolution of the screen 20. The resolutions of the checkerboard images of the plurality of primary colors are the same as that of the screen 20.

If the resolutions of the red, green, and blue checkerboard images are the same as the resolution of the screen 20, and the numbers (e.g., a sum of the number of red color blocks RK and the number of white color blocks WK in the red checkerboard image shown in FIG. 15) of the plurality of color blocks in the red, green, and blue checkerboard image are the same as the number of the micromirrors 2401, the checkerboard image has a large number of color blocks, and the checkerboard image of the reference color has a large number of vertices of the color blocks. As a result, the accuracy of the obtained offset of the second projection position P2 with respect to the first projection position P1 may be improved, so that the number of the determined dispersion correction parameters is large and the dispersion correction effect of the laser projection apparatus is improved.

It will be noted that the laser projection apparatus displays one checkerboard image at a time on the screen 20. Therefore, the laser projection apparatus displays the red checkerboard image, the green checkerboard image, and the blue checkerboard image on the screen 20 in different times.

In some embodiments, the controller 400 may further be configured to: select a plurality of third pixel points in the image of the adjusted color, so as to obtain a plurality of third projection positions of the plurality of third pixel points on the screen 20 and obtain a plurality of offsets of the plurality of third projection positions; obtain a plurality of first distances from the plurality of third projection positions to the projection lens 300; obtain at least one reference range according to the plurality of first distances; and obtain the dispersion correction parameter according to at least one reference range and the plurality of offsets. The plurality of third pixel points are a plurality of pixel points in the image of the adjusted color.

It may be understood that if the plurality of third pixel points are projected at different positions on the screen 20, the first distances between the plurality of third projection positions and the projection lens 300 may not be same, so that the plurality of offsets of the plurality of third projection positions are different. Therefore, the first distances between the plurality of third projection positions and the projection lens 300 may correspond to the plurality of offsets of the plurality of third projection positions, respectively, so as to form a dispersion corresponding relationship (i.e., the dispersion correction parameter).

Thus, in a case of a limited number of selected third pixel points, the number of the obtained plurality of offsets and the number of the obtained plurality of first distances are also limited. At least one reference range is obtained according to the limited number of first distances, and the dispersion correction parameter obtained according to the at least one reference range and the limited number of offsets has a small data amount. In this way, it is possible to reduce the difficulty of the controller 400 to correct the image to be projected according to the dispersion correction parameter. That is to say, the calculation of the controller 400 is reduced. Therefore, some embodiments of the present disclosure may reduce the cost while improving the projection effect of the laser projection apparatus.

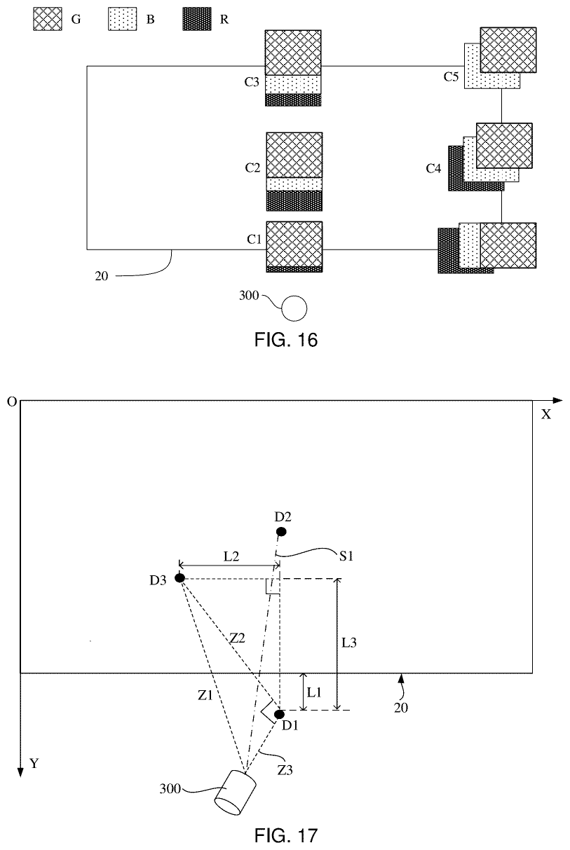

For example, as shown in FIG. 16, the plurality of third projection positions may include a third projection position C1, a third projection position C2, a third projection position C3, a third projection position C4, and a third projection position C5. If the first distance between the third projection position C3 and the projection lens 300 is the same as the first distance between the third projection position C4 and the projection lens 300, the offset of the third projection position C3 is the same as the offset of the third projection position C4. The first distance between the third projection position C1 and the projection lens 300, the first distance between the third projection position C2 and the projection lens 300, and the first distance between the third projection position C3 and the projection lens 300 are different from each other. Therefore, the offsets of the third projection position C1, the third projection position C2, and the third projection position C3 are also different from each other.

The number of the plurality of third projection positions may be six or eight. The number of the plurality of third projection positions, that is, the number of the plurality of third pixel points, is not limited in the present disclosure.

In some embodiments, the controller 400 may also be configured to: obtain a second distance Z2 between a third projection position and an orthogonal projection of the projection lens 300 on a plane where the screen 20 is located; obtain a third distance Z3 between the projection lens 300 and the orthogonal projection of the projection lens 300 on the plane where the screen 20 is located; and obtain the first distance Z1 according to a formula (7).

$$Z 1 = \sqrt{Z {3}^{2} + Z {2}^{2}} \qquad ( 7 )$$

As shown in FIG. 17, the method for obtaining the first distance Z1 between the third projection position D3 and the projection lens 300 is described by considering an example in which the third projection position is D3, the orthogonal projection point of the projection lens 300 on the plane where the screen 20 is located is D1, and the resolution of the screen 20 is 3840×2160.

As shown in FIG. 17, an intersection D2 between an optical axis S1 of the projection lens 300 and the screen 20 is a center point of the screen 20, and the coordinate of the intersection D2 in the first coordinate system may be (1920, 1080). A horizontal coordinate of the orthogonal projection point D1 may be equal to a horizontal coordinate of the intersection point D2, and a distance between the orthogonal projection point D1 and the intersection point D2 may be a sum of 1080 and a distance L1. Therefore, the coordinate of the orthogonal projection point D1 may be (1920, 2160+L1). The distance L1 is the minimum distance between the orthogonal projection point D1 and the screen 20.

If the coordinate of the third projection position D3 is (x0, y0), a difference L2 between the horizontal coordinates of the third projection position D3 and the orthogonal projection point D1 is a difference between 1920 and x0 (i.e., L2=1920−x0), and a difference L3 between vertical coordinates of the third projection position D3 and the orthogonal projection point D1 is a difference between y0 and a sum of 2160 and L1 (i.e., L3=2160+L1−y0). A formula (8) is obtained according to the Pythagorean theorem. The second distance Z2 between the third projection position D3 and the orthogonal projection point D1 may be obtained according to the formula (8).

$$Z {2}^{2} = {( 1920 - x 0 )}^{2} + {( 2160 + L 1 - y 0 )}^{2} \qquad ( 8 )$$

In the formula (8), the distance L1 may be obtained by actual measurement. Similarly, as shown in FIG. 17, the third distance Z3 between the projection lens 300 and the orthogonal projection point D1 may be a distance between the projection lens 300 and the screen 20 in a direction perpendicular to the plane where the screen 20 is located, and the third distance Z3 may also be obtained by actual measurement. For example, the actual measurement is as follows: when the laser projection apparatus is installed, the values of the distance L1 and the third distance Z3 are obtained by measurement and stored in the controller 400.

In a case where the second distance Z2 between the third projection position D3 and the orthogonal projection point D1 and the third distance Z3 between the projection lens 300 and the orthogonal projection point D1 are known, the controller 400 may obtain the first distance Z1 between the third projection position D3 and the projection lens 300 according to the formula (7).

In some embodiments, the controller 400 may also be configured to obtain the plurality of offsets of the plurality of third projection positions in a case where the plurality of first distances are obtained. For the method for controller 400 to obtain the offsets of the plurality of third projection positions, reference may be made to the related content described above.

Generally, the distance between the screen 20 and the projection lens 300 is far, so that the value of the first distance may be large. Therefore, the controller 400 may also be configured to: obtain a plurality of reference distances according to the plurality of first distances; and obtain the at least one reference range according to the plurality of reference distances. The plurality of reference distances are normalized data for the plurality of first distances. For example, the reference distance is a ratio of the first distance to the maximum distance between the projection lens 300 and the screen 20. Normalization processing is a processing manner of simplifying the calculation by converting a dimensional expression manner to a dimensionless expression manner, making parameters scalar.

For example, as shown in FIG. 16, in the plurality of first distances, in a case where the first distance between the third projection position C5 and the projection lens 300 is the maximum distance between the projection lens 300 and the screen 20, if the maximum distance is 5 meters and the first distance between the third projection position C4 and the projection lens 300 is 4 meters, the reference distance of the third projection position C4 is 0.8 (i.e., 0.8=⅘). Values of the plurality of reference distances after the normalization processing are within a closed interval of 0 to 1 (i.e., [0, 1]), inclusive, which may reduce the computation of the controller 400.

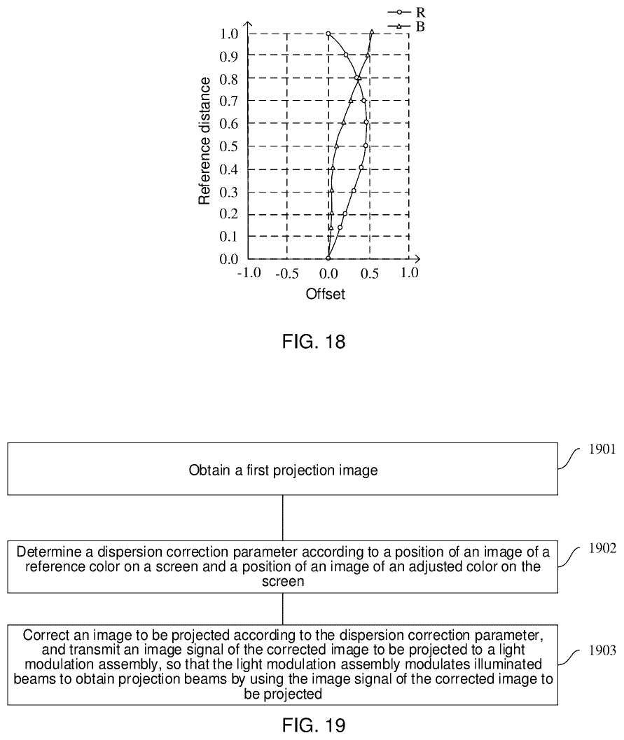

In this case, a plurality of reference ranges may be obtained according to the plurality of reference distances. The controller 400 may correspond the plurality of reference ranges to a plurality of offsets, so as to obtain the dispersion correction parameter. In the dispersion correction parameter, one reference range corresponds to one offset. For example, the dispersion correction parameter may be shown in FIG. 18, the plurality of reference ranges may include an interval [0, 0.1), an interval [0.1, 0.2), . . . , an interval [0.9, 1], and each reference range corresponds to one offset of the image of the adjusted color. For example, as shown in FIG. 18, in a case where the adjusted color is red (R), if the reference distance between the projection position of each pixel point in the red image and the projection lens 300 is within a reference range [0.6, 0.7), the offset of the projection position of each pixel point in the red image is equal to about 0.5.

In a case where the dispersion correction parameter is obtained, the controller 400 may correct the image of the adjusted color in the image to be projected according to the dispersion correction parameter.

In some embodiments, the controller 400 may further be configured to: obtain the first distance between the projection position of each pixel point of the image of the adjusted color in the image to be projected and the projection lens 300; obtain the reference distance of the projection position of each pixel point of the image of the adjusted color in the image to be projected according to the first distance between the projection position of each pixel point of the image of the adjusted color in the image to be projected and the projection lens 300; determine the reference range corresponding to the projection position of each pixel point of the image of the adjusted color in the image to be projected according to the reference distance of the projection position of each pixel point of the image of the adjusted color in the image to be projected and at least one reference range; and obtain the offset of the projection position of each pixel point of the image of the adjusted color in the image to be projected according to the reference range corresponding to the projection position of each pixel point of the image of the adjusted color in the image to be projected and the dispersion correction parameter.

In this way, in a case where the first distance between the projection position of each pixel point of the image of the adjusted color and the projection lens 300 is obtained, the offset of the projection position of each pixel point of the image of the adjusted color may be determined according to the first distance. As a result, the controller 400 may adjust the image of the adjusted color in the image to be projected according to the offset of the projection position of each pixel point of the image of the adjusted color.

In some embodiments, the first projection image may include a plurality of regions. The offsets of the second projection positions in one of the plurality of regions are the same. For the method of obtaining the offsets of the second projection positions in one of the plurality of regions, reference may be made to the related content described above, and details will not be repeated herein.

If the projection position of each of the plurality of pixel points included by the image of the adjusted color on the screen 20 is adjusted, the controller 400 has a lot of computations and the requirement for the controller 400 is high due to the high resolution of the laser projection apparatus. Therefore, the first projection image may be divided into the plurality of regions, and the offsets of the second projection positions in one of the plurality of regions are same. That is to say, the second projection positions in a same region may be adjusted in a same trend, so that the operating program of the controller 400 may be simplified and the efficiency of the controller 400 may be improved.

The present disclosure does not limit the number of the plurality of regions that may be included by the first projection image. For example, the number of the plurality of regions that may be included by the first projection image may be set according to the resolution of the screen 20 and the degree of dispersion caused by the projection lens 300. For example, if the resolution of the screen 20 is 3840×2160, the first projection image may be divided into 32×62 regions, and the offsets of the second projection positions in a same region are same, so that the dispersion correction parameter may include 32×62 offsets, which greatly reduces the computation of the controller 400.

In summary, the laser projection apparatus provided in some embodiments of the present disclosure may obtain the dispersion correction parameter according to the projection position of the image of the adjusted color in the first image on the screen 20 and the projection position of the image of the reference color in the first image on the screen 20 and correct the image to be projected according to the dispersion correction parameter. As a result, the projection positions of the images of different primary colors on the screen 20 are proximate to each other or the same, thereby reducing the dispersion phenomenon.

In some embodiments of the present disclosure, a dispersion correction method for a projection image is also provided, and the method is applied to a laser projection apparatus. The laser projection apparatus includes a laser source assembly 100, a light modulation assembly 200, a projection lens 300, and a controller 400. The method may be performed by the controller 400. As shown in FIG. 19, the method includes step 1901 to step 1903.

In step 1901, a first projection image is obtained.

The first projection image is a projection image projected onto a screen by a first image. The first image includes images of a plurality of primary colors. The plurality of primary colors include a reference color and an adjusted color. The reference color is one of the plurality of primary colors and different from the adjusted color.

In step 1902, a dispersion correction parameter is determined according to a position of the image of the reference color on the screen and a position of the image of the adjusted color on the screen.

In step 1903, an image to be projected is corrected according to the dispersion correction parameter, and an image signal of the corrected image to be projected is transmitted to the light modulation assembly 200, so that the light modulation assembly 200 modulates illuminated beams to obtain projection beams by using the image signal of the corrected image to be projected.

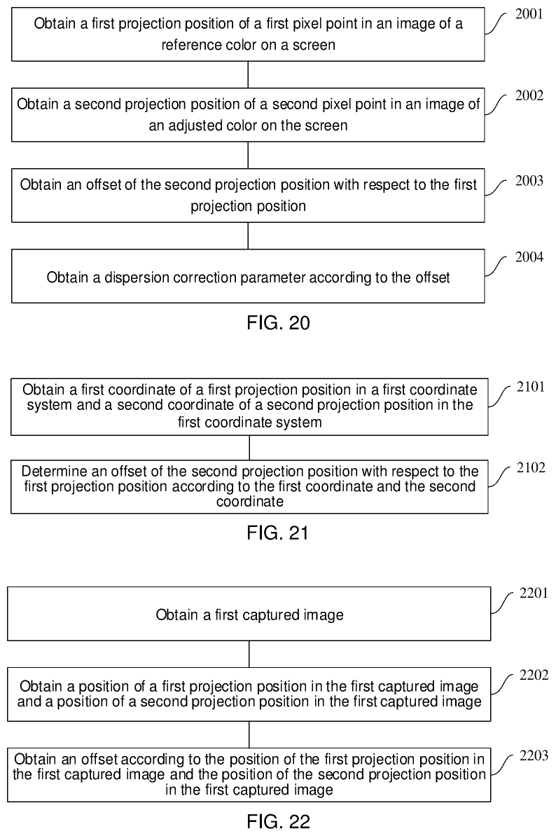

In some embodiments, as shown in FIG. 20, the step 1902 includes step 2001 to step 2004.

In step 2001, a first projection position of a first pixel point in the image of the reference color on the screen is obtained.

The first pixel point is any pixel point in the image of the reference color.

In step 2002, a second projection position of a second pixel point in the image of the adjusted color on the screen is obtained.

A position of the second pixel point in the image of the adjusted color is the same as a position of the first pixel point in the image of the reference color.

In step 2003, an offset of the second projection position with respect to the first projection position is obtained.

In step 2004, the dispersion correction parameter is obtained according to the offset.

In some embodiments, as shown in FIG. 21, the step 2003 includes step 2101 and step 2102.

In step 2101, a first coordinate of the first projection position in a first coordinate system and a second coordinate of the second projection position in the first coordinate system are obtained.

The first coordinate system is a coordinate system established on the screen.

In step 2102, the offset of the second projection position with respect to the first projection position is determined according to the first coordinate and the second coordinate.

In some embodiments, as shown in FIG. 22, the step 2003 includes step 2201 to step 2203.

In step 2201, a first captured image is obtained.

The first captured image is an image captured by a camera device when the first image is projected onto the screen.

In step 2202, a position of the first projection position in the first captured image and a position of the second projection position in the first captured image are obtained.

In step 2203, the offset is obtained according to the position of the first projection position in the first captured image and the position of the second projection position in the first captured image.

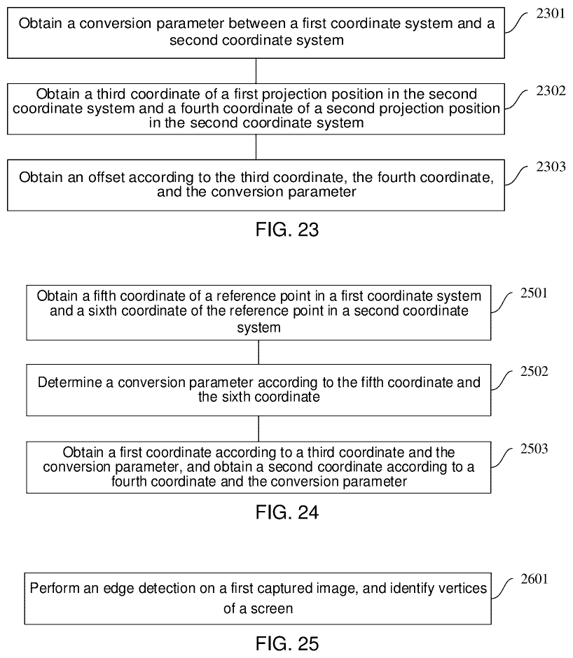

In some embodiments, as shown in FIG. 23, the step 2203 includes step 2301 to step 2303.

In step 2301, a conversion parameter between the first coordinate system and a second coordinate system is obtained.

The first coordinate system is a coordinate system established on the screen. The second coordinate system is a coordinate system established on the first captured image.

In step 2302, a third coordinate of the first projection position in the second coordinate system and a fourth coordinate of the second projection position in the second coordinate system are obtained.

In step 2303, the offset is obtained according to the third coordinate, the fourth coordinate, and the conversion parameter.

In some embodiments, as shown in FIG. 24, the step 2303 includes step 2501 to step 2503.

In step 2501, a fifth coordinate of a reference point in the first coordinate system and a sixth coordinate of the reference point in the second coordinate system are obtained.

The reference point is a point in the screen.

In step 2502, the conversion parameter is determined according to the fifth coordinate and the sixth coordinate.

In step 2503, the first coordinate is obtained according to the third coordinate and the conversion parameter, and the second coordinate is obtained according to the fourth coordinate and the conversion parameter.

The first coordinate is a coordinate of the first projection position in the first coordinate system, and a second coordinate is a coordinate of the second projection position in the first coordinate system.

In some embodiments, as shown in FIG. 25, the step 2501 includes step 2601.

In step 2601, an edge detection is performed on the first captured image, and vertices of the screen are identified.

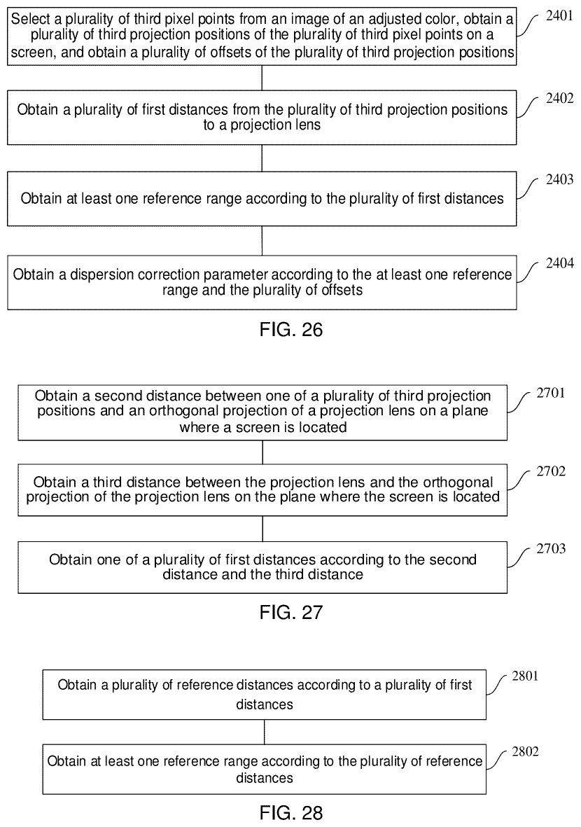

In some embodiments, as shown in FIG. 26, the step 1902 includes step 2401 to step 2404.

In step 2401, a plurality of third pixel points are selected from the image of the adjusted color, and a plurality of third projection positions of the plurality of third pixel points on the screen are obtained, and a plurality of offsets of the plurality of third projection positions are obtained.

The plurality of third pixel points are a plurality of pixel points in the image of the adjusted color.

In step 2402, a plurality of first distances from the plurality of third projection positions to the projection lens are obtained.

In step 2403, at least one reference range is obtained according to the plurality of first distances.

In step 2404, the dispersion correction parameter is obtained according to the at least one reference range and the plurality of offsets.

In some embodiments, as shown in FIG. 27, the step 2402 includes step 2701 to step 2703.

In step 2701, a second distance between one of the plurality of third projection positions and an orthogonal projection of the projection lens on a plane where the screen is located is obtained.

In step 2702, a third distance between the projection lens and the orthogonal projection of the projection lens on the plane where the screen is located is obtained.

In step 2703, one of the plurality of first distances is obtained according to the second distance and the third distance.

In some embodiments, as shown in FIG. 28, the step 2703 includes step 2801 and step 2802.

In step 2801, a plurality of reference distances are obtained according to the plurality of first distances.

The plurality of reference distances are normalized data for the plurality of first distances.

In step 2802, the at least one reference range is obtained according to the plurality of reference distances.

The implementation scheme and beneficial effect of the dispersion correction processing method are the same as that of the laser projection apparatus in some embodiments described above, and details will not be repeated herein.

It will be noted that the steps described in a specific order in the drawings of some embodiments of the present disclosure do not require or imply that these steps must be performed in such specific order or that all the steps shown must be performed to achieve the desired results. Each step in the drawings may be appended, some steps may be omitted, multiple steps may be combined into one step for execution, or one step may be decomposed into multiple steps for execution, etc.

In the above description of the embodiments, specific features, structures, materials, or characteristics may be combined in a suitable manner in any one or more embodiments or examples.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A laser projection apparatus, comprising:
a laser source assembly configured to provide illumination beams;
a light modulation assembly configured to modulate the illumination beams to obtain projection beams by using an image signal of an image to be projected; the image to be projected including a first image;
a projection lens configured to project the projection beams into an image; and
a controller connected to the light modulation assembly and configured to:
obtain a first projection image; the first projection image being a projection image of the first image projected onto a screen; the first image including images of a plurality of primary colors; the plurality of primary colors including a reference color and an adjusted color, the reference color being one of the plurality of primary colors and different from the adjusted color;
determine a dispersion correction parameter according to a position of the image of the reference color on the screen and a position of the image of the adjusted color on the screen; and
correct the image to be projected according to the dispersion correction parameter, and transmit the image signal of the corrected image to be projected to the light modulation assembly, so as to make the light modulation assembly modulate the illumination beams to obtain the projection beams by using the image signal of the corrected image to be projected.

2. The laser projection apparatus according to claim 1, wherein the controller is configured to:
obtain a first projection position of a first pixel point in the image of the reference color on the screen; the first pixel point being any pixel point in the image of the reference color;
obtain a second projection position of a second pixel point in the image of the adjusted color on the screen; a position of the second pixel point in the image of the adjusted color being same as a position of the first pixel point in the image of the reference color;
obtain an offset of the second projection position with respect to the first projection position; and
obtain the dispersion correction parameter according to the offset;
wherein the controller is further configured to:
obtain a first coordinate of the first projection position in a first coordinate system, and a second coordinate of the second projection position in the first coordinate system; the first coordinate system being a coordinate system established on the screen; and
determine the offset of the second projection position with respect to the first projection position according to the first coordinate and the second coordinate.

3. The laser projection apparatus according to claim 2, wherein the offset includes a row offset and a column offset; the row offset is an offset of the second coordinate with respect to the first coordinate in a horizontal direction of the screen, and the column offset is an offset of the second coordinate with respect to the first coordinate in a vertical direction of the screen; at least one of the row offset or the column offset is greater than a resolution of the projection lens.

4. The laser projection apparatus according to claim 2, further comprising an image collecting interface connected to the controller, wherein the controller is further configured to:
obtain a first captured image through the image collecting interface; the first captured image being an image captured by a camera device when the first image is projected onto the screen, and the first captured image including the screen and the first projection image;
obtain a position of the first projection position in the first captured image, and a position of the second projection position in the first captured image; and
obtain the offset according to the position of the first projection position in the first captured image and the position of the second projection position in the first captured image.

5. The laser projection apparatus according to claim 4, wherein the controller is further configured to:
obtain a conversion parameter between the first coordinate system and a second coordinate system; the second coordinate system being a coordinate system established on the first captured image;
obtain a third coordinate of the first projection position in the second coordinate system and a fourth coordinate of the second projection position in the second coordinate system; and
obtain the offset according to the third coordinate, the fourth coordinate, and the conversion parameter.

6. The laser projection apparatus according to claim 5, wherein the controller is further configured to:
obtain a fifth coordinate of a reference point in the first coordinate system and a sixth coordinate of the reference point in the second coordinate system; the reference point being a point in the screen;
determine the conversion parameter according to the fifth coordinate and the sixth coordinate; and
obtain the first coordinate according to the third coordinate and the conversion parameter and the second coordinate according to the fourth coordinate and the conversion parameter.

7. The laser projection apparatus according to claim 6, wherein the reference point includes a vertex of the screen, and the controller is configured to:
perform an edge detection on the first captured image and identify the vertex of the screen.

8. The laser projection apparatus according to claim 1, wherein the controller is further configured to:
select a plurality of third pixel points in the image of the adjusted color, so as to obtain a plurality of third projection positions of the plurality of third pixel points on the screen and a plurality of offsets of the plurality of third projection positions; the plurality of third pixel points being a plurality of pixel points in the image of the adjusted color;
obtain a plurality of first distances from the plurality of third projection positions to the projection lens;
obtain at least one reference range according to the plurality of first distances; and
obtain the dispersion correction parameter according to the at least one reference range and the plurality of offsets.

9. The laser projection apparatus according to claim 8, wherein the controller is configured to:
obtain a plurality of reference distances according to the plurality of first distances; the plurality of reference distances being normalized data for the plurality of first distances; and
obtain the at least one reference range according to the plurality of reference distances.

10. The laser projection apparatus according to claim 8, wherein the controller is configured to:
obtain the first distance from a projection position of each pixel point of the image of the adjusted color in the image to be projected to the projection lens;
obtain a reference distance of the projection position of each pixel point of the image of the adjusted color in the image to be projected according to the first distance from the projection position of each pixel point of the image of the adjusted color in the image to be projected to the projection lens;
determine the reference range corresponding to the projection position of each pixel point of the image of the adjusted color in the image to be projected according to the reference distance of the projection position of each pixel point of the image of the adjusted color in the image to be projected and the at least one reference range; and
obtain the offset of the projection position of each pixel point of the image of the adjusted color in the image to be projected according to the reference range corresponding to the projection position of each pixel point of the image of the adjusted color in the image to be projected and the dispersion correction parameter.

11. The laser projection apparatus according to claim 8, wherein the controller is configured to:
obtain a second distance between one of the plurality of third projection positions and an orthogonal projection of the projection lens on a plane where the screen is located;
obtain a third distance between the projection lens and the orthogonal projection of the projection lens on the plane where the screen is located; and
obtain one of the plurality of first distances according to the second distance and the third distance.

12. The laser projection apparatus according to claim 1, wherein the first projection image includes a plurality of regions; and the offsets of the second projection positions in one of the plurality of regions are same.

13. The laser projection apparatus according to claim 1, wherein the first image includes checkerboard images of the plurality of primary colors, and the controller is configured to:
obtain a resolution of the screen; and
generate the checkerboard images of the plurality of primary colors according to the resolution of the screen; the resolutions of the checkerboard images of the plurality of primary colors being same as the resolution of the screen.

14. The laser projection apparatus according to claim 1, wherein the plurality of primary colors include red, blue, and green, the reference color includes the blue, and the adjusted color includes at least one of the red or the green.

15. A dispersion correction method for a projection image, applied to a laser projection apparatus, the laser projection apparatus including a laser source assembly, a light modulation assembly, a projection lens, and a controller; the method being executed by the controller and comprising:
obtaining a first projection image; the first projection image being a projection image of a first image projected onto a screen; the first image including images of a plurality of primary colors; the plurality of primary colors including a reference color and an adjusted color, the reference color being one of the plurality of primary colors and different from the adjusted color;
determining a dispersion correction parameter according to a position of the image of the reference color on the screen and a position of the image of the adjusted color on the screen; and
correcting an image to be projected according to the dispersion correction parameter, and transmitting an image signal of the corrected image to be projected to the light modulation assembly, so as to make the light modulation assembly modulate illumination beams to obtain projection beams by using the image signal of the corrected image to be projected.

16. The dispersion correction method according to claim 15, wherein the determining the dispersion correction parameter according to the position of the image of the reference color on the screen and the position of the image of the adjusted color on the screen, includes:
obtaining a first projection position of a first pixel point in the image of the reference color on the screen; the first pixel point being any pixel point in the image of the reference color;
obtaining a second projection position of a second pixel point in the image of the adjusted color on the screen; a position of the second pixel point in the image of the adjusted color being same as a position of the first pixel point in the image of the reference color;
obtaining an offset of the second projection position with respect to the first projection position; and
obtaining the dispersion correction parameter according to the offset;
wherein the obtaining the offset of the second projection position with respect to the first projection position includes:
obtaining a first coordinate of the first projection position in a first coordinate system and a second coordinate of the second projection position in the first coordinate system; the first coordinate system being a coordinate system established on the screen; and
determining the offset of the second projection position with respect to the first projection position according to the first coordinate and the second coordinate.

17. The dispersion correction method according to claim 16, wherein the obtaining the offset of the second projection position with respect to the first projection position includes:
obtaining a first captured image; the first captured image being an image captured by a camera device when the first image is projected onto the screen, and the first captured image including the screen and the first projection image;
obtaining a position of the first projection position in the first captured image and a position of the second projection position in the first captured image; and
obtaining the offset according to the position of the first projection position in the first captured image and the position of the second projection position in the first captured image;
wherein the obtaining the offset according to the position of the first projection position in the first captured image and the position of the second projection position in the first captured image includes:
obtaining a conversion parameter between the first coordinate system and a second coordinate system; the second coordinate system being a coordinate system established on the first captured image;
obtaining a third coordinate of the first projection position in the second coordinate system and a fourth coordinate of the second projection position in the second coordinate system; and
obtaining the offset according to the third coordinate, the fourth coordinate, and the conversion parameter.

18. The dispersion correction method according to claim 17, wherein the obtaining the offset according to the third coordinate, the fourth coordinate, and the conversion parameter includes:
obtaining a fifth coordinate of a reference point in the first coordinate system and a sixth coordinate of the reference point in the second coordinate system; the reference point being a point in the screen;
determining the conversion parameter according to the fifth coordinate and the sixth coordinate; and
obtaining the first coordinate according to the third coordinate and the conversion parameter and the second coordinate according to the fourth coordinate and the conversion parameter.

19. The dispersion correction method according to claim 15, wherein the determining the dispersion correction parameter according to the position of the image of the reference color on the screen and the position of the image of the adjusted color on the screen includes:
selecting a plurality of third pixel points in the image of the adjusted color, so as to obtain a plurality of third projection positions of the plurality of third pixel points on the screen and a plurality of offsets of the plurality of third projection positions; the plurality of third pixel points being a plurality of pixel points in the image of the adjusted color;
obtaining a plurality of first distances from the plurality of third projection positions to the projection lens;
obtaining at least one reference range according to the plurality of first distances; and
obtaining the dispersion correction parameter according to the at least one reference range and the plurality of offsets.

20. The dispersion correction method according to claim 19, wherein the obtaining the at least one reference range according to the plurality of first distances includes:
obtaining a plurality of reference distances according to the plurality of first distances; the plurality of reference distances being normalized data for the plurality of first distances; and
obtaining the at least one reference range according to the plurality of reference distances.
